(19) United States
(12) Patent Application Publication
(10) Pub. No.: US 2007/0192856 A1
(43) Pub. Date: Aug. 16, 2007

(54) Method and apparatus for network security

(75) Inventors: John Frank Pillar, Ottawa (CA); Alistair James Scott Boyle, Ottawa (CA); Timothy Buick, Nepean (CA); Bill Hon Yat Fong, Ottawa (CA); David Philip Lapp, Nepean (CA)

Correspondence Address: CASSAN MACLEAN, 307 GILMOUR STREET, OTTAWA, ON, K2P 0P7, CA

(73) Assignee: Freescale Semiconductor, Inc.

(21) Appl. No.: 11/353,162

(22) Filed: Feb. 14, 2006

(51) Int. Cl. G06F 12/14

(52) U.S. Cl. 726/22

(57) ABSTRACT

Methods and systems for determining which groups of instructions are to be executed when a specific symbol patterns has been detected. A prefetch block receives an identification of the symbol pattern detected. The prefetch block then retrieves the groups of instructions which relate to that particular symbol pattern. These are passed to an execution block that retrieves state information for each user defined rule from which the groups of instructions originate. The execution block then checks, for each group of instructions, the state information. If the state information indicates that a particular group of instructions can be executed, the execution block executes that group.

### FIELD OF THE INVENTION

The invention relates to devices for detecting and dealing with specific symbol patterns from data streams. More specifically, the invention relates to a system for detecting events of significance whose presence cannot be concluded from the detection of a single specific symbol pattern.

### BACKGROUND TO THE INVENTION

The field of network security has developed in the last few years in an attempt to render more secure current networks not only from intrusion attacks but from all types of threats. Unfortunately, the types of threats to networks have also equally developed. One development that network security scanners have to deal with is more sophisticated instruction attacks.

Currently, data scanners scan a network's incoming and outgoing data traffic for telltale signs for possible attacks. Specific data or symbol patterns can signal a possible attack. However, some symbol patterns which may appear harmless can be the precursor to a more sophisticated attack. The appearance of such symbol patterns may, by itself, not be a cause for alarm. However, these symbol patterns in conjunction with other events (such as the detection of other symbol patterns that, by themselves, may also seem harmless) may indicate the possible presence of an attack. Present data scanners are unable to or have difficulty with detecting such attacks for detection of such attacks requires complex logic that uses knowledge of previous events in conjunction with present occurrences. Present data scanners are unable to track or test relationships between previous events/symbol patterns and present events/symbol patterns.

Another issue with current data scanners is in their configurability. Given the rapid pace of developments in not only countermeasures against attacks but also in the rapid growth of the variety of attacks, any data scanner system must, ideally, be easily reconfigurable. Such configurability would allow end users to quickly adjust not just the symbol patterns being scanned for but also the various relationships between symbol patterns that may indicate the presence of an event of significance such as an attack.

Based on the above, there is therefore a need for a system which can quickly determine, on the basis of user defined rules, whether a significant event, such as an attack, may be present. Such a system should, ideally, be easily configurable and adjustable to take into account newer and more sophisticated attacks against networks and other data systems.

### BRIEF DESCRIPTION OF THE DRAWINGS

A better understanding of the invention will be obtained by considering the detailed description below, with reference to the following drawings in which:

FIG. 1 illustrates a system for use with a pattern matcher;

FIG. 2 is a sample user generated and defined stateful rule;

FIG. 3 is a schematic diagram of the state memory;

FIG. 4 is a schematic diagram of one partition of the state memory of FIG. 3;

FIG. 5 is a flowchart illustrating a method carried out by a compiler;

FIG. 6 is a flow diagram illustrating how the end user defined rules are converted into a form useful to the system in FIG. 1; and

FIG. 7 is a flowchart illustrating the method carried out by the system of FIG. 1.

### DETAILED DESCRIPTION

The detailed description describes herein embodiments of methods and systems for determining which groups of instructions are to be executed when a specific symbol patterns has been detected. A prefetch block receives an identification of the symbol pattern detected. The prefetch block then retrieves one or more groups of instructions which relate to rules affected by that particular symbol pattern. These are passed to an execution block that retrieves state information for each user defined rule from which the groups of instructions originate. The execution block then checks, for each group of instructions, the state information. If the state information indicates that a particular group of instructions can be executed, the execution block executes that group.

In one embodiment, a system for executing predetermined instructions when a predetermined symbol pattern is detected, said predetermined instructions being based on a plurality of user predetermined rules, the system comprises

a prefetch block for receiving an identification of a detected symbol pattern and for retrieving at least one group of instructions from a reaction memory, the or each group of instructions being identified as being executable only when said detected symbol patterns is detected, the or each group of instructions being associated with one of said plurality of user predetermined rules; and

an execution block for receiving said at least one group of instructions from said prefetch block and for retrieving state data from a state memory, said state data relating to said plurality of user predetermined rules such that each rule is associated with a particular subset of said state data;

wherein for each of said at least one group of instruction received by said execution block from said prefetch block, said execution block retrieves specific state data associated with a rule which is associated with said group of instructions;

and wherein for each group of instructions, said execution block executes the group of instructions received from said prefetch block only if said specific state data indicates that said group of instructions may be executed.

In another embodiment, a method for determining which groups of instructions from a plurality of groups of instructions are to be executed when a specific symbol pattern is detected in a data stream, each group of instructions being associated with one specific user defined rule, the method comprising the steps of:

a) receiving an identification of said specific symbol pattern which has been detected in said data stream;

b) retrieving at least one group of instructions associated with said specific symbol pattern, said at least one group of instructions being executable only when said specific symbol pattern has been detected;

c) retrieving state information associated with specific user defined rules, said specific user defined rules being associated with said at least one group of instructions retrieved in step b);

d) for each group of instructions retrieved in step b), determining if said group of instructions are to be executed based on state information retrieved in step c); and

e) for each group of instructions retrieved in step b), executing said group of instructions in the event said group of instructions are to be executed based on results of step d).

In yet another embodiment, a method of organizing groups of instructions, each group being executable only if a specific symbol pattern is detected, each group being associated with a specific symbol pattern and with one predefined rule, the method comprising the steps of:

a) receiving a plurality of rules, each rule having at least one group of instructions;

b) determining which symbol patterns are associated with multiple groups of instructions;

c) for each symbol pattern, gathering groups of instructions associated with said symbol pattern from said plurality of rules; and

d) for each symbol pattern, storing said groups of instructions as a set of groups associated with said symbol pattern.

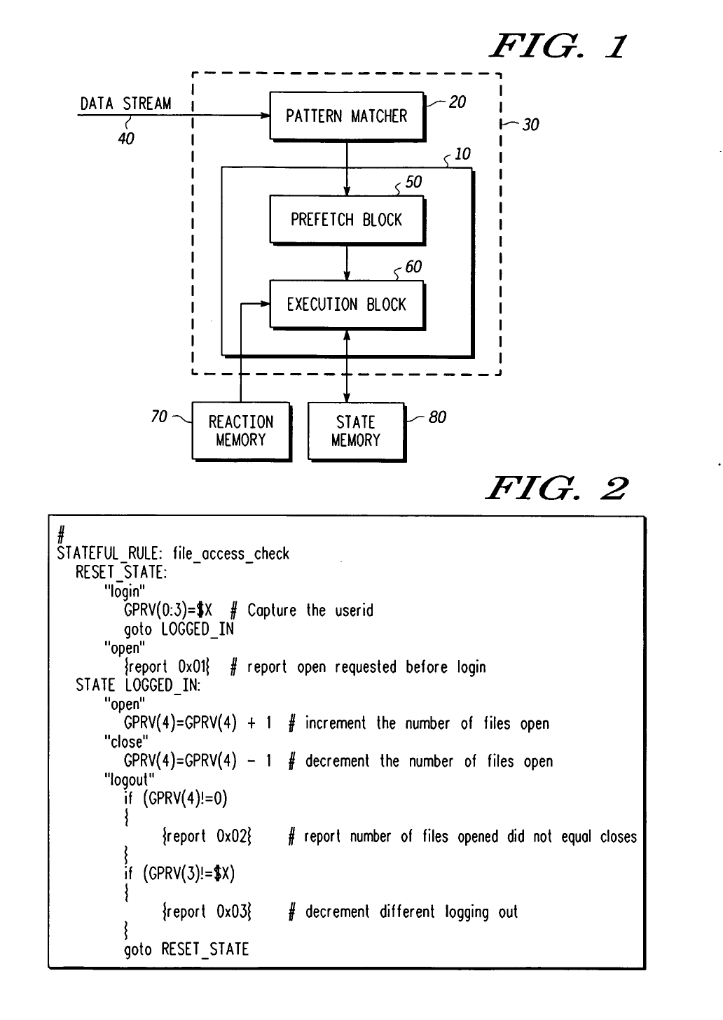

Referring to FIG. 1, a system 10 for use with a pattern matcher 20 is illustrated. The pattern matcher 20 and the system 10 combine to form a complex event detection engine 30. The detection engine 30 receives a data stream 40 and, depending on a symbol pattern found in the data stream 40, reports may be generated to alert an end user.

The data stream 40 is received by the pattern matcher 20. The pattern matcher 20 scans the data stream 40 for specific predetermined symbol patterns preset by the end user. When the pattern matcher 20 detects a symbol pattern it is looking for in the data stream 40, an identification of this detected symbol pattern is sent to the system 10 to determine which rules and which states are affected. It should be noted that, instead of merely the identification of the detected symbol pattern, auxiliary match information may also be sent to the system 10. Such auxiliary match information may be the position of the symbol pattern in the stream and the matched data or a portion of the matched pattern. The matched data or its portion may also be transformed prior to being passed to the system 10. The length of the matched pattern and the time of the detection of the pattern may also form part of the auxiliary match information.

The system 10 has a prefetch block 50 and an execution block 60. The prefetch block 50 receives the identification of the detected symbol pattern with or without the auxiliary match information. The prefetch block 50 then retrieves groups of instructions (or reaction routines) from a reaction memory 70. These reaction routines are the possible measures to be taken when a particular symbol pattern is detected. These varied groups of instructions are then sent to the execution block 60. The symbols surrounding the detected symbol pattern may also be sent to the execution block 60.

After the execution block 60 receives the reaction routines from the prefetch block 50, the execution block 60 retrieves state information from state memory 80. The state information relates to the various groups of instructions received by the execution block 60 from the prefetch block 50. For each group of instructions received by the execution block 60 from the prefetch block 50, the execution block 60 checks related state information form the state memory 80. If the state information indicates that the reaction routine can be executed, then the execution block 60 executes that reaction routine. If, on the other hand, the state information indicates that the reaction routine cannot be executed, the execution block 60 then moves to the next group of instructions. If, because of the execution of the group of instructions, the state information gets altered, the altered state information is written back to the state memory 80.

For clarity, it should be noted that the groups of instructions in the reaction memory and the state information are based on user defined stateful rules. These rules are predetermined and are set by the end user with each rule being for various types of threats, attacks, or contingencies. Each statefull rule contains state information and is defined with different and possibly multiple states, each state having different and possibly multiple relevant or associated patterns. Each relevant or associated symbol pattern has a group of instructions or a reaction routine associated with it, each reaction routine being composed of at least one instruction. The instructions in the reaction routine can be comparisons, logic branches, mathematical operations, logical operations, logic branches based on logical/mathematical tests, and other general operations including state change instructions. It should be clear that, within a rule, different states may have identical associated patterns but with identical associated patterns having possibly different reaction routines associated with them. This means that reaction routines associated with identical associated patterns will only be executed if the rule is in the proper state for that reaction routine.

The user defined rules take a form which looks like the pseudo code description of a classic state machine with, as noted above, comparisons, branches, conditional branches and the like. As an example of such a user defined stateful rule, FIG. 2 shows a stateful rule for a file access check. It can be seen from the example that the symbol pattern “open” occurs in both states RESET_STATE and LOGGED_IN but with different groups of instructions or reaction routines associated with the same pattern for different states. Thus, if, for rule file_access_check, the symbol pattern “open” is detected, the execution block will have to check the state to determine if it is in the reset state (RESET_STATE) or in the logged in state (LOGGED_IN). Based on that determination, the execution block will execute either or neither of the reaction routines associated with the “open” symbol pattern. If the state was in the RESET_STATE, then the first “open” reaction routine would be executed while if the state was in the LOGGED_IN state, then the other “open” reaction routine would be executed. Of course, if other rules also required the “open” symbol pattern, then the reaction routines may also get executed but only after the execution block determines that the state information indicates that they may be executed.

The reaction routines or groups of instruction may perform any of the following operations: addition, subtraction, bitwise AND, and bitwise OR. Within each rule, the reaction routines can use general purpose register values (the GPRV seen in the example) as variables. For logic control, an if/then or if/then/else construct can be used. The condition in the if/then or if/then/else constructs can be mathematical or logical in nature. The conditions can be any of the following: equals (==), not equals (!=), greater than (>), greater than or equal (>=), less than (<), or less than or equal (<=).

The reaction routines also allow for changes to the state that a rule is in. The rules have an initial or reset state, as can be seen from the sample in FIG. 2, and, from this state or any other state, the state can be changed by a goto statement. In contrast to programming languages, the goto statement does not function as a logic flow command but rather as a state switch. If the execution block encounters a state switch or state change in a reaction routine it is executing, the state associated with that rule is changed. The changed state for that rule is then written back or saved in the state memory.

To convert the rules from the end user, a compiler is used. The compiler processes the multiple rules and gathers the various relevant patterns and their associated reaction routines or groups of instructions together such that all reaction routines related to a specific pattern are grouped together. However, it should be noted that each reaction routine, regardless of grouping, is still identified with not only its associated pattern that would trigger the reaction routine's execution but also the rule from which the reaction routine originated and the state the rule has to be in to execute the reaction routine. The groups of reaction routines, their triggering relevant pattern, their triggering state, and an identification of their originating rule can be stored in the reaction memory. It should be noted that the compiler can be constructed according to well-known compiler techniques and technologies. Such techniques can be found in texts such as Compilers by Aho, Sethi, and Ullman (Addison-Wesley, 1986). The grouping of the various reaction routines by their triggering symbol pattern effectively allows the reaction routines to be stored in a database in the reaction memory and to be keyed or indexed by their triggering symbol patterns.

Once the user generated rules have been processed by the compiler software, the groups generated can be stored in the reaction memory and the identification or association with the specific rules is also stored. This association is correlated with the state information in the state memory. In the state memory, each rule is allocated a certain amount of storage so that the state for that rule can be stored. The storage area for each rule may also be used to store data related to relevant patterns detected in the data stream.

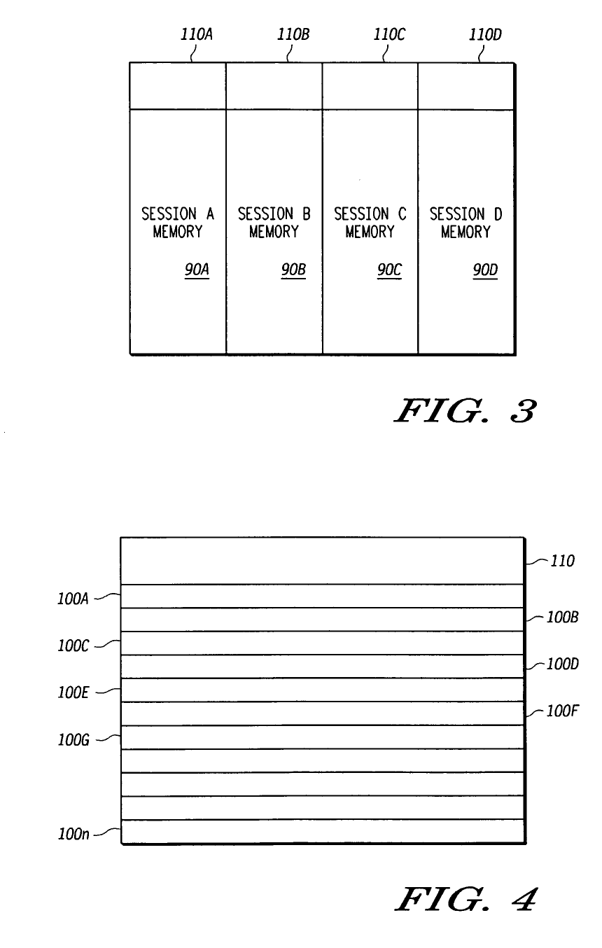

Referring to FIG. 3, a schematic diagram of the state memory is illustrated. As can be seen, the state memory in the example is partitioned into multiple partitions 90A, 90B, 90C, 90D. Each partition 90A-90D corresponds to different sessions being handled by the pattern matching engine. A session may correspond to a network connection whose traffic is being monitored or to a specific incoming or outgoing traffic from a specific network port. Each session is independent of other sessions and the partitioning of the state memory reflects this as each partition is fixed in size and does not encroach into any other partition's storage.

Within each partition, a section of memory is allocated for each rule in the session. This can be seen in the memory diagram of FIG. 4. Each section 100A . . . 100n corresponds to a rule operative for the session. The amount of storage space occupied by each section is dynamic but a minimum is maintained—the storage space for a section can increase but it cannot decrease beyond a certain, predetermined amount. This ensures that each rule for that session has a minimum storage space in which to store its state. This also ensures that, should a rule require data to be stored, such as the surrounding symbols to a particular symbol pattern, the storage space is expandable to store the data. It should be made clear that the rule is not stored in the storage space in the state memory. Indications of the state that a particular rule is in is stored in each rule's designated section, along with, if necessary, supporting data for that state.

For ease of reference and for ease of initialization, a portion of each session's memory is set aside for a quick access section 110 (see 110A-110D in FIG. 3 as well). The quick access section works by taking advantage of the fact that each rule has an initial state. For each rule for a session, a bit in the quick access section is set aside. If that rule is in its initial state, the bit is set to zero. If that rule is not in its initial state, then the bit is set to one. Thus, when the execution block has to check a rule's state, if the bit for that rule is set to zero, then it should be clear that the rule is in its initial state. Also, if a session has to have all of its rules reinitialized, zeroing the quick access section effectively resets all of the rule states.

To allocate the proper amount of storage space to each rule in the state memory, and to store the reaction routines (or groups of instructions) in the reaction memory, linker/loader software is used once the compiler processes the user defined rules. The linker/loader, once it processes the product of the compiler, allocates the proper amount of storage for each rule in the state memory. The linker/loader also determines how much storage is required for the reaction routines to be stored in the reaction memory.

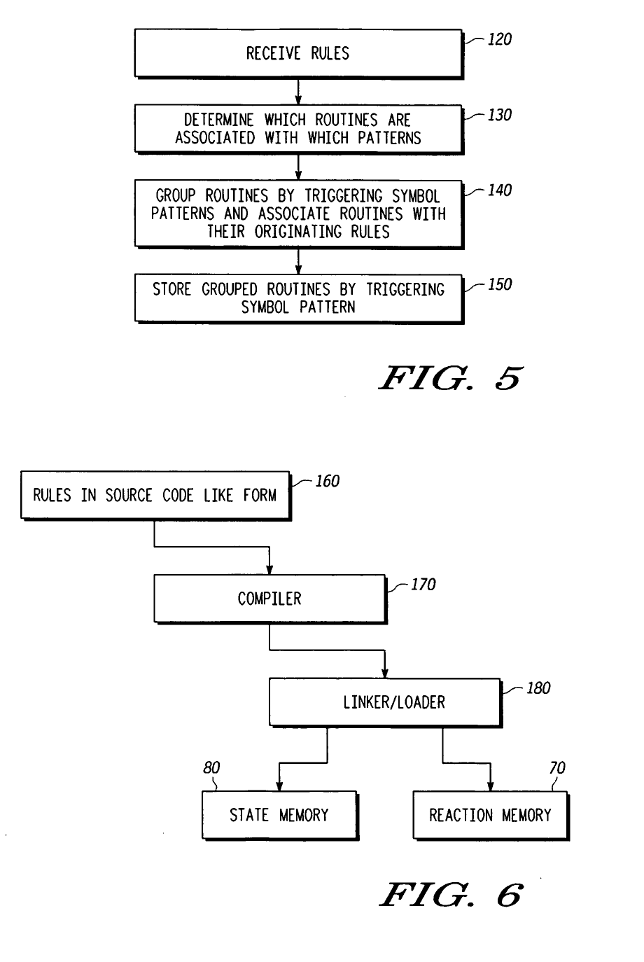

As noted above, the compiler groups the reaction routines according to the triggering symbol patterns. The compiler follows the method outlines in the flowchart of FIG. 5. The method commences with step 120, that of the receipt of the user defined rules. Next, the reactions or reaction routines are determined for each relevant or triggering symbol pattern in step 130. Once it has been determined which reaction routines are associated with which relevant patterns, the reaction routines are grouped by their triggering symbol pattern (step 140). When grouping the reaction routines, the rules they are associated with are also noted, as well as the triggering state for the reaction routine in the rule. Thus, each reaction routine is grouped by their triggering symbol pattern but their association with a rule is preserved. Once properly grouped, the reaction routines are then stored in the reaction memory (step 150). The routines may be stored as linked lists in the reaction memory 70.

For clarity, FIG. 6 is provided. FIG. 6 is a flow diagram illustrating how the end user defined rules are converted from a form which looks like pseudo code to a form usable by the system. The rule “source code” 160 is fed into the compiler software 170. The compiler 170 groups the reaction routines by their triggering symbols and ensures that each reaction routine is still associated with its original rule. The linker/loader software 180 then receives the compiler's product. The linker/loader 180 determines how much memory storage is required for the reaction routines and stores these in the reaction memory 70. The linker/loader 180 also determines how much space to allocate to each rule in the state memory 80. To initialize the state memory 80, the linker/loader 180 can also zero out the quick reference section 110 for each session. As noted above, this effectively initializes all of the states for all of the rules in that particular session.

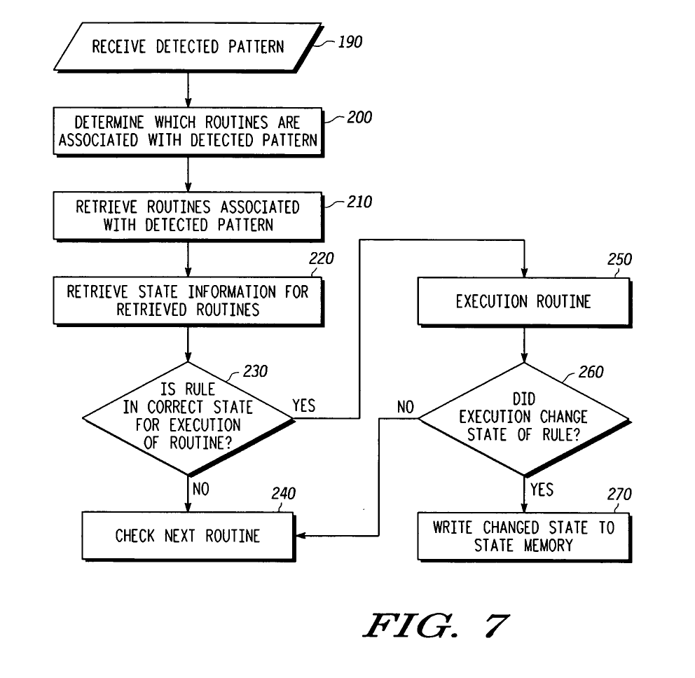

The organization of the reaction routines and the state information allows the execution of the method outlined in the flowchart of FIG. 7. The method starts by receiving either a copy of the matched pattern and an identification of the matched pattern or merely the identification of the matched pattern (step 190). Step 190 may also include the receipt of the auxiliary match information along with the identification of the matched pattern. Step 200 determines which reaction routines in the reaction memory are indexed/keyed or associated with the detected target pattern. Once it has been determined which reaction routines may be triggered by the detected pattern, these reaction routines are retrieved (step 210). The state information for the rules associated with the retrieved reaction routines are also retrieved (step 220). This can be done as each reaction routine retrieved also has identifying information that identifies each reaction routine's original rule. Step 230 then checks the state information for each reaction routine to determine if the rule is in the proper state to execute the reaction routine. Since each reaction routine is stored with not only an identification of the relevant rule but also the state that the rule has to be in to allow execution of the reaction routine, it is simple to check the rule's state to determine if the reaction routine should be executed. If the state information indicates that the reaction routine cannot or should not be executed, then the next reaction routine is checked (step 240). On the other hand, if the state information indicates that the rule is in the correct state, then the reaction routine is executed (step 250). Once the reaction routine has been executed, decision 260 checks if the state has been changed by the reaction routine. If the state has not been changed, then the next reaction routine is checked (step 240). If the state has been changed, then the changed state is written back to the state memory (step 270).

Regarding implementation of the system 10 and of the engine 30, the engine may be implemented as an application specific integrated circuit (ASIC). The pattern matcher 20 may be any pattern matcher subsystem that receives the data stream and compares the data stream symbols with a database of target symbol patterns. One possible pattern matcher is that discussed in US patent application Ser. No. 11/261,480 entitled Data Scan Mechanism, the disclosure of which is incorporated herein by reference.

The system 10 may be a combination of ASIC or combinational circuits. The prefetch block 50, depending on the implementation, may be part of a monolithic ASIC with the execution block 60 being implemented as a processor core. Similarly, the prefetch block 50 may be implemented separately from the execution block 60. However, in the interests of greater speed in throughput, it may be advantageous to have both the prefetch block 50 and the execution block 60 on a single ASIC.

The memory subsystems, the state memory 80 and the reaction memory 70, may be external to the system 10 and even external to the engine 30. These memory subsystems may be implemented as static RAM or dynamic RAM modules coupled closely to the system 10.

The system 10 allows end users to change stateful rules for dealing with various possible intrusion attacks. Should a new threat appear, the end user can develop new stateful rules for dealing with this new threat. The new rules can then be compiled and used with the system, thereby ensuring that the system can detect the new threat and alert the user if that threat materializes. It should be noted that while the above system can execute various instructions for dealing with and detecting various patterns, such as patterns that may be separated by multiple symbols in the data stream, the system can deal with the detection of such patterns by the simple expediency of generating a report for the end user. Thus, for some given patterns, the execution block 60 may generate a specific report while for other patterns, the execution block 60 may generate other reports.

While the principles of the invention have been described above in connection with specific apparatus, it is to be clearly understood that this description is made only by way of example and not as a limitation on the scope of the invention.

A person understanding this invention may now conceive of alternative structures and embodiments or variations of the above all of which are intended to fall within the scope of the invention as defined in the claims that follow.

What is claimed is:

1. A system for executing predetermined instructions when a predetermined symbol pattern is detected, said predetermined instructions being based on a plurality of user predetermined rules, the system comprises
a prefetch block for receiving an identification of a detected symbol pattern and for retrieving at least one group of instructions from a reaction memory, the or each group of instructions being identified as being executable only when said detected symbol patterns is detected, the or each group of instructions being associated with one of said plurality of user predetermined rules; and
an execution block for receiving said at least one group of instructions from said prefetch block and for retrieving state data from a state memory, said state data relating to said plurality of user predetermined rules such that each rule is associated with a particular subset of said state data;
wherein for each of said at least one group of instruction received by said execution block from said prefetch block, said execution block retrieves specific state data associated with a rule which is associated with said group of instructions;
and wherein for each group of instructions, said execution block executes the group of instructions received from said prefetch block only if said specific state data indicates that said group of instructions may be executed.

2. A system according to claim 1 wherein said reaction memory is external to said system.

3. A system according to claim 1 wherein said state memory is external to said system.

4. A system according to claim 1 wherein at least one group of instructions includes at least one instruction selected from the group comprising:
instructions for executing mathematical operations
instructions for comparing one value to another
instructions for logical branches
instructions for conditional branches
instructions for changing a state of a rule

5. A system according to claim 1 wherein at least one group of instructions comprises an instruction for changing retrieved specific state data.

6. A system according to claim 5 wherein said execution block saves specific state data to said state memory after said specific state data has been changed.

7. A system according to claim 1 wherein said user predetermined rules are related to measures for safeguarding network security.

8. A system according to claim 1 wherein said state memory comprises a plurality of entries, each entry being associated with a specific rule in said user predetermined rules.

9. A system according to claim 8 wherein said state memory further comprises a quick access section, said quick access section comprising a plurality of bit entries, each bit entry corresponding to a specific rule on said user predetermined rules.

10. A system according to claim 9 wherein for each bit entry, a value of said bit entry is reflective of a state of said specific rule.

11. A method for determining which groups of instructions from a plurality of groups of instructions are to be executed when a specific symbol pattern is detected in a data stream, each group of instructions being associated with one specific user defined rule, the method comprising the steps of:
a) receiving an identification of said specific symbol pattern which has been detected in said data stream;
b) retrieving at least one group of instructions associated with said specific symbol pattern, said at least one group of instructions being executable only when said specific symbol pattern has been detected;
c) retrieving state information associated with specific user defined rules, said specific user defined rules being associated with said at least one group of instructions retrieved in step b);
d) for each group of instructions retrieved in step b), determining if said group of instructions are to be executed based on state information retrieved in step c); and
e) for each group of instructions retrieved in step b), executing said group of instructions in the event said group of instructions are to be executed based on results of step d).

12. A method according to claim 11 wherein steps a) and b) are executed by a prefetch block in a system for executing predetermined instructions when a predetermined symbol pattern is detected.

13. A method according to claim 11 wherein steps c), d), and e) are executed by an execution block in a system for executing predetermined instructions when a predetermined symbol pattern is detected.

14. A method according to claim 11 wherein step d) further comprises checking said state information to determine if said rule associated with said group of instructions is in a triggering state for said group of instructions.

15. A method according to claim 11 wherein step c) comprises checking a quick access section in a state memory to determine if at least one rule is in an initial state.

16. A method according to claim 11 further comprising the step of storing state information in the event an execution of a particular group of instructions changes said state information.

17. A method of organizing groups of instructions, each group being executable only if a specific symbol pattern is detected, each group being associated with a specific symbol pattern and with one predefined rule, the method comprising the steps of:
a) receiving a plurality of rules, each rule having at least one group of instructions;
b) determining which symbol patterns are associated with multiple groups of instructions;
c) for each symbol pattern, gathering groups of instructions associated with said symbol pattern from said plurality of rules; and
d) for each symbol pattern, storing said groups of instructions as a set of groups associated with said symbol pattern.

18. A method according to claim 17 wherein said method is executed by a compiler.

19. A method according to claim 17 wherein said plurality of rules relate to network security.
